(19) United States
(12) Patent Application Publication
(10) Pub. No.: US 2009/0133601 A1
(43) Pub. Date: May 28, 2009

(54) Electronic Pneumatic Spring Controller for Reducing Air Consumption and Rapidly Adjusting the Setpoint Level

(76) Inventors: Christian Kitzmuller, Graz (AT); Klaus Six, Stainztal (AT); Martin Teichmann, Graz (AT); Herwig Waltensdorfer, Graz (AT); Gerhard Weilguni, Graz (AT)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/224,905

(22) PCT Filed: Dec. 6, 2006
(86) PCT No.: PCT/EP2006/069382

§ 371 Date: Sep. 9, 2008

(30) Foreign Application Priority Data
Mar. 13, 2006 (AT) A407/2006

(51) Int. Cl. B61F 5/10; B60G 17/052

(52) U.S. Cl. 105/198.1

(57) ABSTRACT

Disclosed is a railway vehicle comprising at least one pneumatic spring for supporting a body. At least one mechanically actuated valve is disposed in at least one air supply/discharge tube of the at least one pneumatic spring in order to control air exchange of the at least one pneumatic spring. At least one switching means is provided between the at least one mechanical valve and the at least one pneumatic spring in the at least one air supply/discharge tube in order to control air exchange. Alternatively, at least one switching means is arranged between the at least one mechanical valve and at least one pressure source while at least one additional switching means is placed in a tube that connects the at least one mechanical valve to an environment in order to control air exchange.

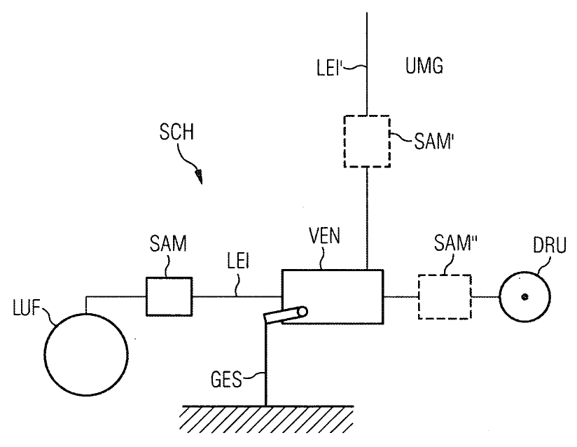

### CROSS REFERENCE TO RELATED APPLICATIONS

This application is the US National Stage of International Application No. PCT/EP2006/069382, filed Dec. 6, 2006 and claims the benefit thereof. The International Application claims the benefits of Austrian application No. A 407/2006 filed Mar. 13, 2006, both of the applications are incorporated by reference herein in their entirety.

### FIELD OF INVENTION

The invention relates to a rail vehicle having at least one pneumatic spring for supporting a railcar body, wherein at least one mechanically actuatable valve is disposed in at least one air supply/discharge line of the at least one pneumatic spring for the purpose of controlling the air exchange of the at least one pneumatic spring.

The invention also relates to a method for operating at least one pneumatic spring for supporting a railcar body of a rail vehicle, wherein at least one mechanically actuatable valve is disposed in at least one air supply/discharge line of the at least one pneumatic spring for the purpose of controlling the air exchange of the at least one pneumatic spring.

### BACKGROUND OF INVENTION

In rail vehicles of the type referred to in the introduction, use is typically made of mechanical valves which can be actuated via an arrangement of levers disposed on the undercarriage of the rail vehicle, the valve being opened and closed as a function of the difference in height between the valve and a lower anchorage point of the lever arrangement on the undercarriage. In addition to a maximally rapid correction of the secondary spring deflections caused by changes in payload in stations, one of the main functions of mechanical pneumatic spring valves is also to assure a minimally small dynamic air consumption on the track. These requirements result in a configuration conflict, for the resolution of which valves having special valve characteristic curves are used according to the prior art. In this case the valve typically has three valve cross-sections. In the event of large setpoint level deviations the valve opens completely and the system is quickly corrected close to the setpoint level. In the event of medium setpoint level deviations the valve cross-section assumes an intermediate position, and in the event of small setpoint level deviations the valve is closed altogether.

One of the disadvantages of the solution according to the prior art is that when the vehicle is traveling along the track the mechanical valve may sometimes be fully open, e.g. in curves, which results in a corresponding consumption of air.

### SUMMARY OF INVENTION

It is therefore an object of the invention to overcome the aforementioned disadvantages.

This object is achieved according to the invention with a rail vehicle of the type referred to in the introduction in that at least one switching means is provided between the at least one mechanical valve and the at least one pneumatic spring in the at least one air supply/discharge line for the purpose of controlling the air exchange, or in that at least one switching means is disposed between the at least one mechanical valve and the at least one pressure source, and at least one additional switching means is disposed in a line that connects the at least one mechanical valve to the environment for the purpose of controlling the air exchange.

As a result of the solution according to the invention it is possible to interrupt the airflow in the air exchange line between the mechanical valve and the pneumatic spring, thereby enabling the configuration conflict referred to in the introduction to be resolved. Thus, when the vehicle is traveling along the track the switching means can be closed, thereby reducing the dynamic air consumption essentially to zero. Furthermore, owing to the solution according to the invention it is also possible to use mechanical valves with a substantially larger cross-section, as a result of which the speed of adjustment of the setpoint level can be increased.

The at least one switching means disposed between the at least one valve and the at least one pneumatic spring or the at least one switching means disposed between the at least one valve and the at least one pressure source as well as the at least one further switching means are preferably controllable electrically and/or electronically.

The at least one switching means disposed between the at least one valve and the at least one pneumatic spring or the at least one switching means disposed between the at least one valve and the at least one pressure source as well as the at least one further switching means can also be switchable by means of a door opening signal.

It can also be provided that the at least one switching means disposed between the at least one valve and the at least one pneumatic spring or the at least one switching means disposed between the at least one valve and the at least one pressure source as well as the at least one further switching means is or are switchable by means of a signal generated if the rail vehicle exceeds or falls below a limit running speed.

As a result of the coupling of the switching means to the above-cited signals it is possible, owing to the reliability of said signals, to achieve very reliable control over the air exchange.

In order to control the air exchange in a defined manner and therefore predictably and reliably, the air exchange of the at least one pneumatic spring can be performed in at least two predefinable operating modes by means of the at least one switching means disposed between the at least one valve and the at least one pneumatic spring or by means of the at least one switching means disposed between the at least one valve and the at least one pressure source as well as of the at least one further switching means.

The at least one switching means can be brought into an open switching position at defined time intervals so that for a certain length of time the system behaves like a conventional system. Leakage currents can be very efficiently prevented in this way. The at least one switching means can also be controlled taking into account a measured vertical and/or lateral acceleration of the rail vehicle, the switching means being opened only when the rail vehicle is located on a straight section of track so as not to compromise the operating reliability or safety of the rail vehicle. The vertical and/or lateral acceleration of the rail vehicle can be measured by means of corresponding acceleration sensors.

For safety reasons a limit switch can be provided which shuts off the power to the at least one switching means disposed between the at least one valve and the at least one pneumatic spring or the switching means disposed between the at least one valve and the at least one pressure source as well as the at least one further switching means before an upper or lower extreme position of the vehicle level is reached.

In order to detect unacceptably large spring deflections, as can arise e.g. due to a leak, when a switching means is in the closed state and open the control valve for the purpose of delivering extra air or issuing a diagnostic message, at least one sensor can be provided for monitoring extreme positions of the pneumatic spring and/or of the at least one mechanically actuatable valve, which sensor is electronically connected to the at least one switching means disposed between the at least one valve and the at least one pneumatic spring or the switching means disposed between the at least one valve and the at least one pressure source and the at least one further switching means, the power to the switching means being shut off before an upper or lower extreme position of the vehicle level is reached.

An advantageous variant of the invention provides that the at least one switching means disposed between the at least one valve and the at least one pneumatic spring or the switching means disposed between the at least one valve and the at least one pressure source as well as the at least one further switching means is or are implemented as a valve or valves.

In a particularly favorable embodiment of the invention it is provided that the air exchange of the pneumatic spring can be choked by means of the at least one switching means disposed between the at least one valve and the at least one pneumatic spring or by means of the switching means disposed between the at least one valve and the at least one pressure source as well as by means of the at least one further switching means.

In this embodiment of the invention the switching means is used not to interrupt the connecting line between the mechanical valve and the pneumatic spring, but only to reduce the effective cross-section of the air supply/discharge line, thereby enabling the valve characteristic curve of the mechanical pneumatic spring valve to be scaled. This can also be achieved e.g. by means of a switchable 3/2-way valve and a bypass line provided with a choke.

It can also be provided that the at least one switching means disposed between the at least one valve and the at least one pneumatic spring or the switching means disposed between the at least one valve and the at least one pressure source as well as the at least one further switching means is or are open in a powered-off state.

The aforesaid object can also be achieved according to the invention by means of a method of the type referred to in the introduction, wherein the air exchange of the at least one pneumatic spring is controlled by at least one switching means disposed between the at least one valve and the at least one pneumatic spring or by at least one switching means disposed between the at least one valve and the at least one pressure source and by at least one further switching means disposed in a line connecting the at least one mechanical valve to an environment.

Further advantageous variants of the method according to the invention may be derived from the dependent claims.

### BRIEF DESCRIPTION OF THE DRAWINGS

The invention together with further advantages is explained in more detail below with reference to several non-limiting exemplary embodiments that are illustrated in the drawing. The single FIGURE shows a rail vehicle according to the invention in schematic form.

### DETAILED DESCRIPTION OF INVENTION

As shown in the FIGURE, a rail vehicle according to the invention has at least one pneumatic spring LUF which forms a secondary spring for supporting a railcar body. At least one mechanically actuatable valve VEN is disposed in at least one air supply/discharge line LEI between a pressure source DRU and the pneumatic spring LUF or the pneumatic spring LUF and an environment UMG for the purpose of controlling the air exchange. The mechanical valve VEN can be actuated by way of an arrangement of levers GES disposed on an undercarriage of the rail vehicle SCH. If the rail vehicle subsides due to being loaded, the valve VEN is opened by means of the lever arrangement GES toward the pressure source DRU, resulting in an inflow of air from the pressure source DRU into the pneumatic spring LUF. If the pneumatic spring LUF rebounds beyond a setpoint position, it is vented to the environment UMG by way of the valve VEN.

According to a first variant of the invention, at least one switching means SAM is disposed only between the mechanical valve VEN and the pneumatic spring LUF in the air supply/discharge line LEI for the purpose of controlling the air exchange.

As an alternative to the switching means SAM disposed between the valve VEN and the pneumatic spring LUF, a switching means SAM″ can be provided between the valve VEN and the pressure source DRU, which switching means SAM″ interacts with a further switching means SAM′. In this arrangement the switching means SAM′ is disposed in a line LEI′ connecting the valve VEN to the environment UMG.

The switching means SAM or, as the case may be, the switching means SAM′, SAM″ can in each case be embodied for example as a valve or as a shut-off valve.

The switching means SAM or, as the case may be, the switching means SAM′, SAM″ can also be controllable electronically or electrically and be operated by way of a motor (not shown here) in each case. In an embodiment of the switching means SAM or switching means SAM′, SAM″ as a choke valve or choke valves, for example, said motor can modify the position of a valve tappet and consequently change the flow rate through the associated switching means SAM, SAM′, SAM″. In an embodiment of the switching means SAM or the switching means SAM′, SAM″ as a shut-off valve or as shut-off valves, the air supply/discharge line LEI or LEI′ can be fully opened or closed by means of the motor. The motor can be mounted directly onto the top of the associated switching means. SAM, SAM′, SAM″. In a simple embodiment of the invention the associated switching means SAM, SAM′, SAM″ can be controlled for example via 2 electrical connections which drive the motor directly. If an OPEN connection is selected, the valve SAM, SAM′, SAM″ is opened by the motor. With a CLOSE connection, the valve SAM, SAM′, SAM″ is closed by the motor.

According to a further variant of the invention, the switching means SAM or, as the case may be, the switching means SAM′, SAM″ can also be controlled via an analog control signal, the analog value of the voltage that is applied corresponding to the respective opening of the switching means SAM, SAM′, SAM″. In this case the switching means SAM, SAM′, SAM″ can be opened in a continuously variable manner. The conversion of the analog signal in the switching means SAM, SAM′, SAM″ into the exact position is likewise effected by means of a motor. The latter can in turn be controlled by means of integrated electronics. If a valve is used as switching means SAM, SAM′, SAM″, the air exchange can also be choked in a very simple manner. A solenoid valve or proportional valve, for example, is particularly well suited as switching means SAM, SAM′, SAM″ for this purpose.

The switching means SAM, SAM′, SAM″ is preferably controlled by means of a door opening signal. This enables the switching means SAM or, as the case may be, the switching means SAM′ and SAM″ to be opened when the rail vehicle is stationary and after the door opening signal has been received. Once the rail vehicle is in motion, a further signal is usually generated if the vehicle exceeds a limit speed. Said signal can be used for example to close the switching means SAM or the switching means SAM′ and SAM″. Said signals are characterized by an exceptional reliability, as a result of which very reliable operation of the air exchange can be achieved. Even while the vehicle is in motion, if it exceeds or falls below the limit running speed, the switching means SAM or, as the case may be, the switching means SAM′ and SAM″ can be actuated accordingly in order to control the air exchange in accordance with predefined operating states. The air exchange can therefore be operated in different modes by the inventive use of the switching means SAM or the switching means SAM′ and SAM″.

For safety reasons the switching means SAM or the switching means SAM′ and SAM″ can be open in the powered-off state to ensure that the system will always behave like a conventional system if, for example, supply cables are disconnected. This can be achieved, for example, through the use of valves that are open in the powered-off state as switching means SAM, SAM′, SAM″. In addition it can be ensured with the aid of a limit switch or by means of sensors that the switching means SAM or the switching means SAM′ SAM″ is or are powered off and hence open before an anti-derail device or an emergency spring is reached and that the system will again behave like a conventional system. Upon actuation of the limit switch or with the aid of the sensors it is also possible to generate a diagnostic signal which enables an extreme position of the vehicle level to be detected.

1.-21. (canceled)

22. A rail vehicle, comprising:
at least one pneumatic spring for supporting a railcar body, wherein at least one mechanically actuatable valve is disposed in at least one air supply/discharge line of the at least one pneumatic spring for the purpose of controlling the air exchange of the at least one pneumatic spring;
at least one switching device either in the at least one air supply/discharge line between the at least one mechanical valve and the at least one pneumatic spring for the purpose of controlling the air exchange, or between the at least one mechanical valve and at least one pressure source; and
at least one further switching device disposed in a line connecting the at least one mechanical valve to an environment for the purpose of controlling the air exchange.

23. The rail vehicle as claimed in claim 22, wherein the at least one switching device disposed between the at least one valve and the at least one pneumatic spring or the at least one switching means disposed between the at least one valve and the at least one pressure source as well as the at least one further switching device are controlled electrically and/or electronically.

24. The rail vehicle as claimed in claim 23, wherein the at least one switching device disposed between the at least one valve and the at least one pneumatic spring or the at least one switching means disposed between the at least one valve and the at least one pressure source as well as the at least one further switching device are switched based upon a door opening signal.

25. The rail vehicle as claimed in claim 22, wherein the at least one switching device disposed between the at least one valve and the at least one pneumatic spring or the at least one switching device disposed between the at least one valve and the at least one pressure source as well as the at least one further switching device are switched based upon a signal that is generated if the rail vehicle exceeds or falls below a limit running speed.

26. The rail vehicle as claimed in claim 22, wherein an air exchange of the at least one pneumatic spring is to be performed in at least two predefinable operating modes based upon the least one switching device disposed between the at least one valve and the at least one pneumatic spring, or based upon the at least one switching device disposed between the at least one valve and the at least one pressure source as well as based upon the at least one further switching device.

27. The rail vehicle as claimed in claim 22, wherein the at least one switching device is brought into an open switching position at defined time intervals.

28. The rail vehicle as claimed in claim 27, wherein the at least one switching device is controlled taking into account a measured vertical and/or lateral acceleration of the rail vehicle.

29. The rail vehicle as claimed in claim 22, wherein a limit switch is provided which shuts off the power to the at least one switching device disposed between the at least one valve and the at least one pneumatic spring or the switching device disposed between the at least one valve and the at least one pressure source as well as the at least one further switching device before an upper or lower extreme position of the vehicle level is reached.

30. The rail vehicle as claimed in claim 22, wherein at least one sensor is provided for monitoring extreme positions of the pneumatic spring and/or of the at least one mechanically actuatable valve, which sensor is electronically connected to the at least one switching device disposed between the at least one valve and the at least one pneumatic spring or to the switching device disposed between the at least one valve and the at least one pressure source and the at least one further switching device, the power to the switching device or the switching devices is shut off before an upper or lower extreme position of the vehicle level is reached.

31. The rail vehicle as claimed in claim 22, wherein the at least one switching device disposed between the at least one valve and the at least one pneumatic spring or the switching device disposed between the at least one valve and the at least one pressure source as well as the at least one further switching device is or are implemented as a valve or valves.

32. The rail vehicle as claimed in claim 22, wherein the at least one switching device disposed between the at least one valve and the at least one pneumatic spring or the switching device disposed between the at least one valve and the at least one pressure source as well as the at least one further switching device is or are embodied as a shut-off valve or shut-off valves.

33. The rail vehicle as claimed in claim 22, wherein the air exchange of the pneumatic spring is choked via the at least one switching device disposed between the at least one valve and the at least one pneumatic spring or via the switching device disposed between the at least one valve and the at least one pressure source as well as via the at least one further switching device.

34. The rail vehicle as claimed in claim 22, wherein the at least one switching device disposed between the at least one valve and the at least one pneumatic spring or the switching device disposed between the at least one valve and the at least one pressure source as well as the at least one further switching device is or are open in a powered-off state.

35. A method for operating at least one pneumatic spring for supporting a railcar body of a rail vehicle, comprising:
providing at least one mechanically actuatable valve disposed in at least one air supply/discharge line of the at least one pneumatic spring for the purpose of controlling the air exchange of the at least one pneumatic spring; and
controlling the air exchange of the at least one pneumatic spring by at least one switching device disposed between the at least one valve and the at least one pneumatic spring or by at least one switching device disposed between the at least one valve and the at least one pressure source and by at least one further switching device disposed in a line connecting the at least one mechanical valve to an environment.

36. The method as claimed in claim 35, wherein at least one switching device disposed between the at least one valve and the at least one pneumatic spring or the switching device disposed between the at least one valve and the at least one pressure source as well as the at least one further switching device is or are controlled electronically.

37. The method as claimed in claim 35, wherein the at least one switching device disposed between the at least one valve and the at least one pneumatic spring or the switching device disposed between the at least one valve and the at least one pressure source as well as the at least one further switching device is or are controlled by means of a door opening signal.

38. The method as claimed in claim 35, wherein at least one switching device disposed between the at least one valve and the at least one pneumatic spring or the switching device disposed between the at least one valve and the at least one pressure source as well as the at least one further switching device is or are controlled by means of a signal that is generated if the rail vehicle exceeds or falls below a limit running speed.

39. The method as claimed in claim 35, wherein the air exchange of the at least one pneumatic spring is operated in at least two predefinable operating modes based upon the at least one switching device disposed between the at least one valve and the at least one pneumatic spring or based upon the switching device disposed between the at least one valve and the at least one pressure source and based upon the at least one further switching device.

40. The method as claimed in claim 25, wherein the at least one switching device is brought into an open switching position at defined time intervals.

41. The method as claimed in claim 40, wherein the at least one switching device is controlled taking into account a measured vertical and/or lateral acceleration of the rail vehicle, and wherein extreme positions of the at least one pneumatic spring and/or the at least one mechanical valve are monitored, the switching position of the at least one switching device disposed between the at least one valve and the at least one pneumatic spring or of the switching device disposed between the at least one valve and the at least one pressure source and of the at least one further switching device being predefined taking into account the extreme positions.
